(19) United States
(12) Patent Application Publication
(10) Pub. No.: US 2011/0239960 A1
(43) Pub. Date: Oct. 6, 2011

(54) TUBE ARRANGEMENT FITTING FOR HEAT TRANSFER TUBES

(75) Inventors: Nobuyoshi Komai, Nagasaki (JP); Takeshi Miyazawa, Nagasaki (JP); Kiyotaka Aoki, Nagasaki (JP); Sachio Iwamoto, Nagasaki (JP); Masahiro Kobayashi, Nagasaki (JP)

(73) Assignee: MITSUBISHI HEAVY INDUSTRIES, LTD., Tokyo (JP)

(21) Appl. No.: 13/139,630

(22) PCT Filed: Dec. 24, 2009
(86) PCT No.: PCT/JP2009/071407

§ 371 Date: Jun. 14, 2011

(30) Foreign Application Priority Data
Apr. 20, 2009 (JP) 2009-102093

(51) Int. Cl. F22B 37/24; F16L 3/22

(52) U.S. Cl. 122/493; 248/68.1

(57) ABSTRACT

Deflection (bend) in the length direction due to a difference in the heat expansion between two plate-like members, between which rows of heat transfer tubes are sandwiched, is reduced, and deflection (bend) of rows of heat transfer tubes is prevented. Two long plate-like members, in which a plurality of cutouts along the longitudinal direction are provided in one side the widthwise direction, are provided, and each of the cutouts includes two rectilinear sections that extend in a direction perpendicular to the longitudinal direction axis of the plate-like members, and a semicircular section that links one end of the rectilinear sections together. The distance between the two rectilinear sections along the lengthwise direction axis of the plate-like members and the diameter of the semicircular section is set so as to be greater than the diameter of the heat transfer tubes that are contained within the cutouts. Tongue sections are provided both between adjacent cutouts and between the cutouts positioned at both end portions of the plate-like members in the length direction and both side surfaces of the plate-like members in the lengthwise direction.

### TECHNICAL FIELD

The present invention relates to a tube arrangement fitting for heat transfer tubes that holds heat transfer tubes forming, for example, a superheater and a reheater of a boiler, at a predetermined interval, and is attached to the heat transfer tubes, which are arranged substantially in parallel, in order to prevent misalignment of the rows of heat transfer tubes.

### BACKGROUND ART

The invention disclosed, for example, in Patent Publication 1 is known as such a tube arrangement fitting for heat transfer tubes.

### CITATION LIST

### Patent Literature

{PTL 1} Japanese Unexamined Patent Application, First Publication No. 2008-185308

### SUMMARY OF INVENTION

### Technical Problem

In this context, in order to suppress the generation of scale on the surface inside a tube (inner peripheral surface of a tube) due to steam, in recent years stainless steel tubes that have had a shot blast treatment applied to the inside surface thereof have become widely used.

However, there is a concern that the treated layer to which the shot blast treatment has been applied will be restored due the heating input during welding (which will decrease the effect) and that sensitization will occur due to welding heat input. Thus, the tube arrangement fitting (slide spacer) for the heat transfer tubes, disclosed in Patent Publication 1, in which the heat transfer tubes (piping) are joined by welding, is unsuitable for tubes that have had a shot blast treatment applied to the inside surface thereof.

Thus, in recent years, as shown in FIG. 6A and FIG. 6B, a tube arrangement fitting 60 for heat transfer tubes has been proposed in which the welded section is extremely reduced (minimized).

The tube arrangement fitting 60 for heat transfer tubes includes two plate-like members 61 exhibiting the same shape. The plate-like members 61 are long thin plate-like members that exhibit a cross-sectional square “U” shape, having for dimensions, for example, a length of 940 mm (longitudinal), a width of 76 mm (transverse), and a thickness of 6 mm plate thickness.

The rows of heat transfer tubes are sandwiched between a back surface (outside surface of a central section in a width direction) 62 of one plate-like member 61 and a back surface 62 of another plate-like member 61. In addition, spacers 63, which are inserted between the heat transfer tubes 15, are disposed at locations separated by a predetermined interval (within a necessary minimum range) between the back surface 62 of one plate-like member 61 and the back surface 62 of the other plate-like member 61. In addition, spacers 64 are disposed between both end sections of the back surface 62 of the one plate-like member 61 in the length direction and both end sections of the back surface 62 of the other plate-like member 61 in the length direction.

As shown in FIG. 6A, the spacers 63 are a plate-like member that exhibit a cross-sectional squared “U” shape, and the length thereof (the length in the vertical direction in FIG. 6A) is set so as to be slightly greater (for example, 1.4 mm to 4 mm) than the diameter of the heat transfer tubes 15, and the width thereof (the length in the horizontal direction in FIG. 6A) is set so as to be slightly less (for example, 1.4 mm to 4 mm) than the distance between heat tubes 15.

The plate-like members 61, which are disposed such that their back surfaces 62 oppose each other, are linked (joined) via a fastening member (for example, a bolt and nut) 65 at locations at which the spacers 63 are disposed.

In addition, the lower surfaces 61a of the plate-like members 61 and the outer surfaces 15a of the heat transfer tubes 15 are joined by welding at locations separated by a predetermined interval (within a necessary minimum range). Note that reference numeral 66 in FIG. 6A and FIG. 6B indicates welded sections.

However, in the tube arrangement fitting 60 for heat transfer tubes that is shown in FIG. 6A and FIG. 6B, when there is a temperature difference between one plate-like member 61 and another plate-like member 61, there are problems in that a difference in heat expansion occurs in the length direction, deflection (bend) occurs in the length direction, and deflection (bend) occurs in the rows of heat transfer tubes.

The present invention provides a tube arrangement fitting for heat transfer tubes that takes into consideration the above circumstances, and can reduce deflection (bend) in the lengthwise direction due to a difference in heat expansion between two plate-like members, between which rows of heat transfer tubes are sandwiched, and can prevent deflection (bend) of the rows of heat transfer tubes.

### Solution to Problem

The present invention uses the following devices to solve the problems described above.

The tube arrangement fitting for heat transfer tubes according to a first aspect of the present invention is a tube arrangement fitting for heat transfer tubes that holds heat transfer tubes that are arranged substantially in parallel at a predetermined interval and prevents the misalignment of the rows of heat transfer tubes, the tube arrangement fitting including two long plate-like members in which a plurality of cutouts is provided, along the longitudinal direction thereof, on one side in the width direction, and wherein each of the cutouts includes two rectilinear sections that extend in a direction perpendicular to the longitudinal direction axis of the plate-like members and a semicircular section that links one end of the rectilinear sections together, and the distance between the two rectilinear sections along the longitudinal direction axis of the plate-like members and the diameter of the semicircular section are set so as to be greater than the diameter of the heat transfer tubes that are contained within the cutouts; and tongue sections are respectively provided between adjacent cutouts and between cutouts positioned at both end sections of the plate-like members in the lengthwise direction and both side surfaces in the longitudinal direction of the plate-like members.

In the tube arrangement fitting for heat transfer tubes according to the first aspect of the present invention, a structure is formed in which one heat transfer tube row is fit in a cutout formed in two plate-like members and the distal end surfaces of the tongue sections are joined (for example, by joined by welding) to those of another corresponding single plate-like member, and thereby, the surface of the tongue section formed on one plate-like member and the surface of the tongue section formed on the other plate-like member are brought into contact.

Due to this structure, the heat possessed by one plate-like member can be smoothly (efficiently) transferred (heat transferred) to the other plate-like member via the tongue sections formed on each of the plate-like members, deflection (bend) in the length direction due to a difference in the heat expansion between the two plate-like members, between which rows of heat transfer tubes are sandwiched, can be reduced, and the deflection (bend) of the rows of heat transfer tubes can be prevented.

In the tube arrangement fitting for heat transfer piping according to the first aspect of the present invention, a structure is formed in which, for example, the bottom surface of the plate-like member positioned below and the outer surface of the heat transfer tubes are joined by welding at locations that are separated by a predetermined interval (within a necessary minimum range), and attached to the rows of heat transfer tubes.

According to this structure, the welded section for attaching the tube arrangement fitting for heat transfer tubes to the rows of heat transfer can be reduced to a minimum, and restoration and sensitization due to heating input of the shot blast treatment surface that has been applied to the surface inside the tube can be prevented.

In the tube arrangement fitting for heat transfer tubes according to the first aspect of the present invention, the distance between two rectilinear sections of a cutout along the longitudinal direction axis of a plate-like member and the diameter of a semicircular section are set so as to be greater than the diameter of the heat transfer tubes contained within a cutout, and thus, the expansion and contraction of the heat transfer tubes in the radial direction and the expansion and contraction of the heat transfer tubes in the longitudinal direction (axial direction) can be tolerated, and deformation due to the expansion and contraction of the heat transfer tubes in the radial direction and the expansion and contraction of the heat transfer tubes in the longitudinal direction can be prevented.

A tube arrangement fitting for heat transfer tubes according to a second aspect of the present invention is a tube arrangement fitting for heat transfer tubes that holds heat transfer tubes arranged substantially in parallel at a predetermined interval and prevents misalignment of the rows of heat transfer tubes, the tube arrangement fitting including a long first plate-like member that exhibits a cross-sectional square “U” shape; a second plate-like member that is longer than this first plate-like member and exhibits a cross-sectional square “U” shape; spacers that are disposed between adjacent heat transfer tubes and are sandwiched between the back surface of the first plate-like member and the back surface of the second plate-like member; fastening members that link the first plate-like member and the second plate-like member; and holding members, which exhibit a cross-sectional squared “U” shape, that are attached to the outer surface of both end sections of the first plate-like member in the width direction and hold the second plate-like member in a state in which the expansion and contraction in the longitudinal direction thereof is not restricted; wherein the length of the spacers in a direction perpendicular to the longitudinal direction axis of the first plate-like member and the second plate-like member is set so as to be greater than the diameter of the heat transfer tubes, and the length along the lengthwise direction axis of the first plate-like member and the second plate-like member is set so as to be less than the distance between adjacent heat transfer tubes.

In the tube arrangement fixture for heat transfer tubes according to the second aspect of the present invention, the second plate-like member can freely expand and contract in the longitudinal direction with respect to the first plate-like member, and thus, deflection (bend) in the length direction due to a difference in the heat expansion between the two plate-like members, between which rows of heat transfer tubes are sandwiched, can be reduced, and deflection (bend) of the rows of heat transfer tubes can be prevented.

In the tube arrangement fitting for heat transfer tubes according to the second aspect of the present invention, a structure is formed in which, for example, the bottom surface of the first plate-like member and the outer surface of the heat transfer tubes are joined by welding at locations separated by a predetermined interval (within a necessary minimum range), and attached to the rows of heat transfer tubes.

Due to this structure, the welded section for attaching the tube arrangement fitting for heat transfer tubes to the rows of heat transfer tubes can be reduced to a minimum, and restoration and sensitization due to heating input of the shot blast treated layer that has been applied to the surface inside the tube can be prevented.

In the tube arrangement fitting for heat transfer tubes according to the second aspect of the present invention, the length of the spacers in a direction perpendicular to the lengthwise direction axis of the first plate-like member and the second plate-like member is set so as to be greater than the diameter of the heat transfer tubes, and the length of the first plate-like member and the second plate-like member along the lengthwise direction axis is set so as to be less than the distance between adjacent heat transfer tubes, and thus, expansion and contraction of the heat transfer tubes in the radial direction and the expansion and contraction of the heat transfer tubes in the longitudinal direction (axial direction) can be tolerated, and deformation due to expansion and contraction of the heat transfer tubes in the radial direction and the expansion and contraction of the heat transfer tubes in the lengthwise direction can be prevented.

In the tube arrangement fitting for heat transfer tubes according to the second aspect of the present invention, a structure may be formed in which the fastening member is disposed only at the center of the first plate-like member and the second plate-like member in the longitudinal direction.

According to this structure, because the expansion and contraction of the second plate-like member freely occurs without any restriction, deflection (bend) in the length direction due to a difference in heat expansion between the two plate-like members, between which rows heat transfer tubes are sandwiched, can be further reduced, and deflection (bend) of the heat transfer tubes can be more reliably prevented.

In the tube arrangement fitting for heat transfer tubes according to the first and second aspects of the present invention, a structure may be formed in which the spacers are disposed between all adjacent heat transfer tubes.

According to this structure, the heat possessed by one plate-like member can be smoothly (efficiently) transferred (heat transferred) to the other plate-like member via the spacers disposed between the plate-like members, deflection (bend) in the lengthwise direction due to a difference in heat expansion between the two plate-like members, in which the rows of heat transfer tubes are sandwiched, can be further reduced, and deflection (bend) of the rows of heat transfer tubes can be more reliably prevented.

A tube arrangement fitting for heat transfer tubes according to a third aspect of the present invention is a tube arrangement fitting for heat transfer tubes that holds heat transfer tubes arranged substantially in parallel at a predetermined distance and prevents the misalignment of the rows of heat transfer tubes, the tube arrangement fitting including two long plate-like members that exhibit a cross-sectional square “U” shape; spacers that are disposed between adjacent heat transfer tubes and fit between the back surfaces of the plate-shaped members; and a bolt and nut that link the plate-like members together, wherein the length of the spacers in a direction perpendicular to the lengthwise direction axis of the plate-like members is set so as to be greater than the diameter of the heat transfer tubes, and the length of the plate-like members along the lengthwise direction axis is set so as to be less than the distance between adjacent heat transfer tubes, and a long hole, into which the distal end section of the bolt on the nut side is received, is provided along the lengthwise direction axis of the plate-like member in the plate-like member disposed at the nut side.

In the tube arrangement fitting for heat transfer tubes according to the third aspect of the present invention, even if one plate-like member expands or contracts, the expansion and contraction is permitted (absorbed) by the long hole, and thus, deflection (bend) in the length direction due to a difference in the heat expansion of the two plate-like members, between which rows of heat transfer tubes are sandwiched, can be reduced, and deflection (bend) of the rows of heat transfer tubes can be prevented.

In the tube arrangement fitting for heat transfer tubes according to the third aspect of the present invention, a structure is formed in which, for example, the bottom surface of one plate-like member and the outer surfaces of the heat transfer tubes are joined by welding at locations separated by a predetermined interval (within a necessary minimum range), and attached to the rows of heat transfer tubes.

According to this structure, the welded section for attaching the tube arrangement fitting for heat transfer tubes to the rows of heat transfer tubes can be reduced to a minimum, and restoration and sensitization due to heating input of the shot blast treatment layer applied to the surface inside a tube can be prevented.

In the tube arrangement fixture for heat transfer tubes according to the third aspect of the present invention, the length of the spacers in a direction perpendicular to the lengthwise direction axis of the plate-like member is set so as to be greater than the diameter of the heat transfer tubes, and the length of the plate-like member along the lengthwise direction axis is set so as to be less than the distance between adjacent heat transfer tubes, and thus, the expansion and contraction of the heat transfer tubes in a radial direction and the expansion and contraction of the heat transfer tubes in the longitudinal direction (axial direction) can be tolerated, and deformation due to the expansion and contraction of the heat transfer tubes in the radial direction and the expansion and contraction of the heat transfer tubes in the longitudinal direction can be prevented.

A boiler according to a fourth aspect of the present invention is provided with a tube arrangement fitting for heat transfer tubes in which deflection (bend) in the length direction due to a difference in heat expansion of two plate-like members, between which rows of heat transfer tubes are sandwiched, can be reduced, and deflection (bend) of the rows of heat transfer tubes can be prevented.

According to the boiler for a heat transfer tubes according to the fourth aspect of the present invention, deflection (bend) of the rows of heat transfer tube can be prevented, and thus, performance reductions of the boiler can be prevented, and the reliability of the boiler can be improved.

### ADVANTAGEOUS EFFECTS OF INVENTION

In the tube arrangement fitting for heat transfer tubes according to the present invention, the effect is achieved in which the deflection (bend) in the length direction due to a difference in heat expansion between the two plate-like members, between which rows of heat transfer tubes are sandwiched, can be reduced, and the deflection (bend) of the rows of heat transfer tubes can be prevented.

### BRIEF DESCRIPTION OF DRAWINGS

FIG. 1A is a plan view that shows the state in which the tube arrangement fitting for heat transfer tubes according to a first embodiment of the present invention has been assembled.

FIG. 1B is a cross-sectional view along arrow I-I in the plan view shown in FIG. 1.

FIG. 2 is a plan view that shows the state before the tube arrangement fitting for heat transfer tubes that is shown in FIG. 1A are assembled.

FIG. 3 is a side view that shows the state in which the tube arrangement fitting for heat transfer tubes according to the first embodiment of the present invention is attached to the rows of heat transfer tubes.

FIG. 4A is a plan view that shows the state in which the tube arrangement fitting for heat transfer tubes according to the second embodiment of the present invention is attached to the rows of heat transfer tubes.

FIG. 4B is a side view in which the plan view that is shown in FIG. 4A is viewed from the left side direction (the front side of the boiler).

FIG. 5A is a drawing that shows the state in which the tube arrangement fitting for heat transfer tubes according to the third embodiment of the present invention is assembled, and is a cross-sectional view at a location where the fastening section is disposed.

FIG. 5B is a drawing in which the cross-sectional view shown in FIG. 5A is viewed from the right side.

FIG. 6A is a plan view that shows the state in which a conventional tube arrangement fitting for heat transfer tubes is assembled.

FIG. 6B is a drawing in which the plan view that is shown in FIG. 6A is viewed from below.

### DESCRIPTION OF EMBODIMENTS

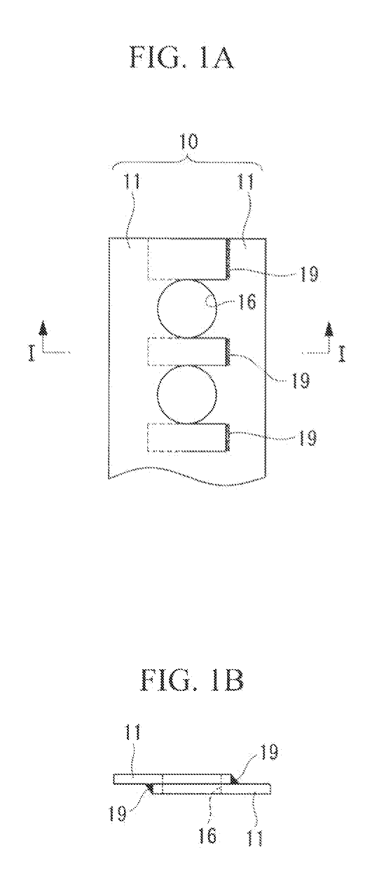

Below, the tube arrangement fitting for heat transfer tubes according to a first embodiment of the present invention will be explained with reference to FIG. 1A to FIG. 3.

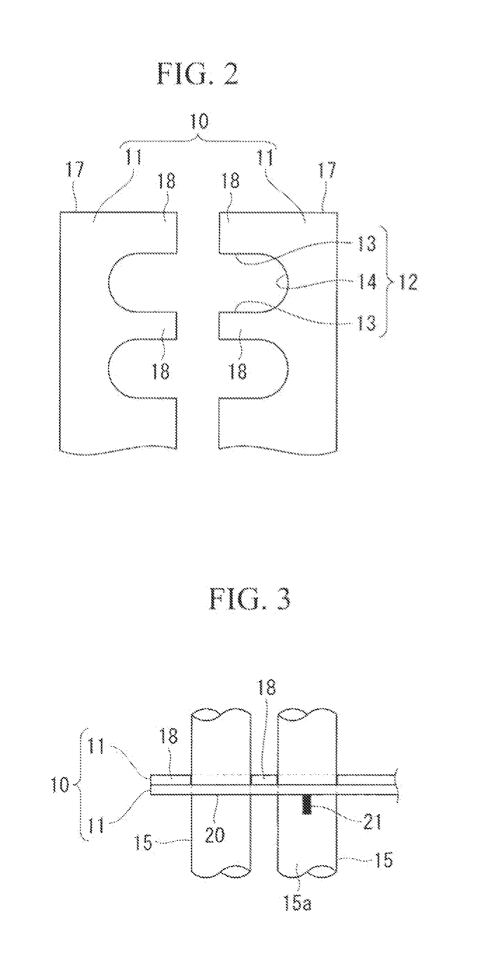

FIG. 1A is a plan view that shows the state in which the tube arrangement fitting for heat transfer tubes according to the present embodiment is assembled, and FIG. 1B is a cross-sectional view along the arrow I-I in FIG. 1A. FIG. 2 is a plan view that shows the state before the tube arrangement fitting for heat transfer tubes that is shown in FIG. 1A is assembled. FIG. 3 is a side view that shows the state in which the tube arrangement fitting for heat transfer tubes according to the present embodiment is attached to the rows of heat transfer tubes.

The tube arrangement fitting for heat transfer tubes according to the present invention is one that holds heat transfer tubes that form, for example, an overheater or a reheater for a boiler, at a predetermined distance, and that is installed on heat transfer tubes that are arranged substantially in parallel to prevent misalignment of the rows of heat transfer tubes.

As shown in FIG. 2, the tube arrangement fitting 10 for heat transfer tubes according to the present embodiment includes two plate-like members 11 that exhibit identical shapes.

The plate-like members 11 are thin plate members having for dimensions, for example, a length of 940 mm (longitudinal), a width of 76 mm (transverse), and a thickness of 6 mm, and on one side in the width direction, a plurality of cutouts 12 are provided along the length direction.

The cutouts 12 each have two rectilinear sections 13 that extend in a direction perpendicular to the lengthwise direction axis of the plate-like members 11 and a semicircular section 14 that links (joins) one end of these rectilinear sections 13 together. The distance between a rectilinear section 13 and a rectilinear section 13 along the longitudinal direction axis of the plate-like members 11 and the diameter of the semicircular section 14 are set so as to be slightly greater (for example, 1.4 mm to 4 mm) than the diameter of the heat transfer tubes 15 (refer to FIG. 3) that are accommodated (held) in the cutout 12. Specifically, as shown in FIG. 1, when the two plate-like members 11 have been assembled, each of the cutouts 12 has an inner circumference circle 16 formed in the center section in the width direction, and the inner circumference circle 16 is slightly greater than the outer circumference (a circle that forms the outer surface of the heat transfer tubes) 15a of a heat transfer tube 15 that is contained within the cutout 12.

In addition, as shown in FIG. 2, tongue sections 18 are each provided between adjacent cutouts 12 and between cutouts 12 that are positioned at both ends of the plate-like members 11 in the length direction and both end surfaces 17 of the plate-like members 11 in the length direction. In addition, as shown in FIG. 1A and FIG. 1B, the distal end surface of the tongues 18 are joined by welding to those of the other corresponding plate-like member 11 after one row of heat transfer tubes has been sandwiched between the two plat-like members 11. Note that reference numeral 18 in FIG. 1A and FIG. 1B indicates a welded section.

When one row of heat transfer tubes has been sandwiched between two plate-like members 11 and the distal end sections of the tongue sections 18 have been joined by welding to those of the other one corresponding plate-like member, the bottom surface 20 of the plate-like member 11 positioned below and the outer surface 15a of a heat transfer tube 15 are joined by welding at locations separated by a predetermined interval (within a necessary minimum range), and the tube arrangement fitting 10 for the heat transfer tube is fastened to the rows of heat transfer tubes. Note that reference numeral 12 in FIG. 3 indicates welded sections.

In the tube arrangement fitting 10 for heat transfer tubes according to the present embodiment, one row of heat transfer tubes is fit inside the cutouts 12 that are formed in two plate-like members 11, and the distal end sections of the tongue sections 18 are joined by being welded to those of the corresponding other one plate-like member 11. Thereby, the surface of tongue sections 18 formed in one plate-like member 11 and the surface of the tongue sections 18 formed in the other plate-like 11 member are brought into contact.

Thereby, heat possessed by one plate-like member 11 can be smoothly (efficiently) transferred (heat transferred) to the other plate-like member 11 via the tongues 18 that are formed in the plate-like members 11, deflection (bend) in the length direction due to a difference in heat expansion between the two plate-like members 11, between which the rows of heat transfer tubes are sandwiched, can be reduced, and deflection (bend) of the rows of heat transfer tubes can be prevented.

In addition, in the tube arrangement fitting 10 for heat transfer tubes according to the present embodiment, for example, the lower surface 20 of the plate-like member 11 positioned below and the outer surface 15a of the heat transfer tube 15 are joined by welding at locations separated by a predetermined interval (within a necessary minimum range), and attached to the rows of heat transfer tubes.

Thereby, the welded sections 21 for attaching the tube arrangement fitting 10 for heat transfer tubes to the rows of heat transfer tubes can be reduced to a minimum, and restoration and sensitization due to heating input of the shot blast treatment layer that has been applied to the surface inside the tube can be prevented.

Furthermore, in the tube arrangement fitting 10 for heat transfer tubes according to the present embodiment, in the cutouts 12, the distance between the two rectilinear sections along the longitudinal direction axis of the plate-like member 11 and the diameter of the semicircular section 14 are set so as to be greater than the diameter of the heat transfer tubes 15 that are contained within the cutouts 12, and thus, the expansion and contraction of the heat transfer tubes 15 in the radial direction and the expansion and contraction of the heat transfer tubes 15 in the longitudinal direction (axial direction) can be tolerated, and deformation due to the expansion and contraction of the heat transfer tubes 15 in the radial direction and the expansion and contraction of the heat transfer tubes 15 in the longitudinal direction can be prevented.

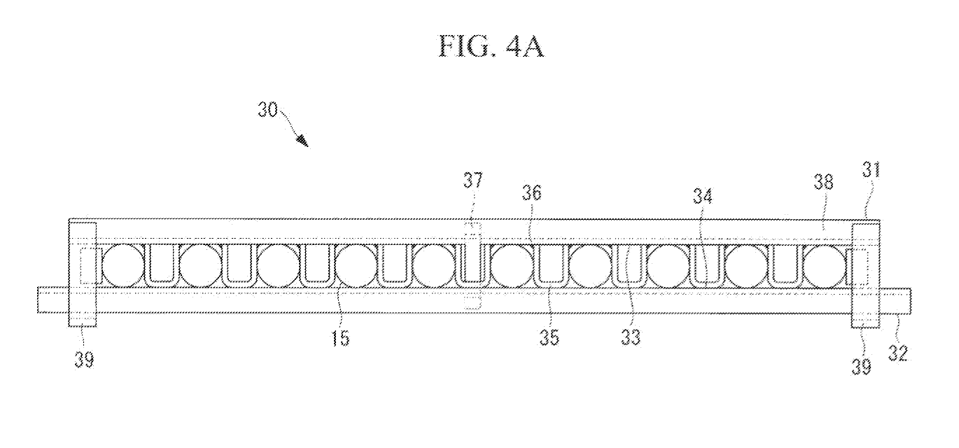

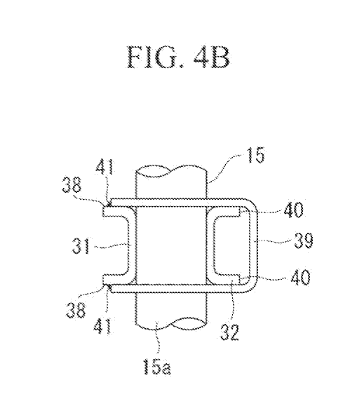

A tube arrangement fitting for heat transfer tubes according to a second embodiment of the present invention will be explained with reference to FIG. 4A and FIG. 4B. FIG. 4A is a plan view that shows the state in which the tube arrangement fitting for heat transfer tubes according to the present embodiment are installed on the rows of heat transfer tubes, and FIG. 4B is a side view in which the plan view that is shown in FIG. 4A is viewed from the left side (the front side of the boiler).

As shown in FIG. 4A and FIG. 4B, the tube arrangement fitting 30 for heat transfer tubes according to the present embodiment includes a first plate-like member 31 that exhibits a squared “U” shape and a second plate-like member 32 that is slightly longer (for example, 5 mm to 10 mm) than the first plate-like member 31 and that exhibits a cross-sectional squared “U” shape.

The first plate-like member 31 is a thin plate member having for dimensions, for example, a length of 940 mm (longitudinal), a width of 76 mm (transverse), and a 6 mm thickness, and the second plate-like member 32 is a thin plate member having dimensions of, for example, a length of 945 mm to 950 mm (longitudinal), a width of 76 mm (transverse), and a thickness of 6 mm.

In the present embodiment, rows of heat transfer tubes are sandwiched between the back surface (the outside surface of the center section in the width direction) 33 of the first plate-like member 31 and the back surface (the outside surface of the center section in the width direction) 34 of the second plate-like member 32. In addition, both end sections of the spacers 35 that are inserted between heat transfer tubes 15 are joined by welding to the back surface 33 of the first plate-like member 31.

As shown in FIG. 4A, the spacer 35 is a plate-like member that exhibits a cross-sectional squared “U” shape, and the length (the length in the vertical direction in FIG. 4A) is set so as to be slightly greater (for example, 1.4 mm to 4 mm) than the diameter of a heat transfer tube 15, and the width (the length in the horizontal direction in FIG. 4A) is set so as to be slightly less (for example, 1.4 mm to 4 mm) than the distance between heat transfer tubes 15. Note that reference numeral 36 in FIG. 4A indicates the welded section that joins both ends of the spacer 35 and the back surface 33 of the first plate-like member 31.

The first plate-like member 31 and the second plate-like member 32, which are disposed such that the back surface 33 and the back surface 34 are opposed, are linked (joined) only via a fastening member (for example, a bolt and nut) 37 that is disposed at the center in the length direction thereof.

As shown in FIG. 4A and FIG. 4B, at both end portions of the first plate-like member 31 in the length direction, both ends of a holding section 39, which hold the second plate-like member 32 in a state that does not restrict (does not hinder) the expansion and contraction in the length direction thereof, are joined by welding to both side surfaces (the outside surfaces at both end sections in the width direction) 38 of the first plate-like member 31.

As shown in FIG. 4B, the holding member 39 is a plate-like member that exhibits a cross-sectional squared “U” shape. The inner dimension thereof in the length direction (the length in the horizontal direction in FIG. 4B) is set such that a slight gap (for example, 5 mm) is formed between the holding member 39 and both end surfaces 40 of the second plate-like member 32 when both end sections of the holding member 39 have been welded. The inner dimension thereof in the width (the length in the vertical direction in FIG. 4B) direction is set so as to be slightly (for example, 1 mm) greater than the distance (outer dimension) between both side surfaces of the first plate-like member 31. Note that reference numeral 41 in FIG. 4B indicates the welded sections that joins both end sections of the holding member 39 and both side sections 38 of the first plate-like member 31. In addition, similar to the first embodiment described above, the first plate-like member 31 and the outer surface 15a of a heat transfer tube 15 are joined by welding at locations separated by a predetermined interval (within a necessary minimum range).

In the tube arrangement fitting 30 for heat transfer tubes according to the present embodiment, the second plate-like member 32 can freely expand and contract in the lengthwise direction thereof with respect to the first plate-like member 31, and thus, deflection (bend) in the length direction due to a difference in heat expansion between the two plate-like members 31 and 32, between which rows of heat transfer tubes rows are sandwiched, can be reduced, and deflection (bend) of the heat transfer tube row can be prevented.

In addition, in the tube arrangement fitting 30 for heat transfer tubes according to the present embodiment, the lower surface of the first plate-like member 31 and the outer surface 15 of the heat transfer tubes 15 are joined by welding at locations separated by a predetermined interval (within a necessary minimum range), and attached to the rows of heat transfer tubes.

Thereby, the welded sections 21 (refer to FIG. 3) for attaching the tube arrangement fitting 30 for heat transfer tubes to the rows of heat transfer tubes can be reduced to a minimum, and the restoration and sensitization due to heating input of the shot blast treatment layer that has been applied to the surface inside the tubes can be prevented.

Furthermore, in the tube arrangement fitting 30 for heat transfer tubes according to the present embodiment, the length of spacers 35 perpendicular to the longitudinal direction axis of the first plate-like member 31 and the second plate-like member 32 is set so as to be greater than the diameter of the heat transfer tubes 15, and the length of the first plate-like member 31 and the second plate-like member 32 along the longitudinal direction is set so as to be less than the distance between adjacent heat transfer tubes 15, and thus, the expansion and contraction of the heat transfer tubes 15 in the radial direction and the expansion and contraction of the heat transfer tubes 15 in the longitudinal direction (axial direction) can be tolerated, and the deformation due to the expansion and contraction of the heat transfer tubes 15 in the radial direction and the expansion and contraction of the heat transfer tubes 15 in the longitudinal direction can be prevented.

In the tube arrangement fitting 30 for heat transfer tubes according to the present embodiment, the fastening member 37 is disposed only at the center of the first plate-like member 31 and the second plate-like member 32 in the longitudinal direction, and the expansion and contraction of the second plate-like member 32 can occur freely without any restriction, and thus, deflection (bend) in the length direction due to a difference in heat expansion between the two plate-like members 31 and 32, between which rows of heat transfer tubes are sandwiched, can be further reduced, and deflection (bend) of the rows of heat transfer tubes can be more reliably prevented.

In the tube arrangement fitting 30 for heat transfer tubes according to the present application, spacers 35 are disposed between all adjacent heat transfer tubes 15, and thus, the heat possessed by one plate-like member 32 (or 31) can be smoothly (efficiently) transferred (heat transferred) to the other plate-like member 31 (or 32) via the spacers 35 disposed between the plate-like members 31 and 32, deflection (bend) in the length direction due to the expansion and contraction of the two plate-like members 31 and 32, between which rows of plate-like members are sandwiched, can be further reduced, and deflection (bend) of the heat transfer tube rows can be more reliably prevented.

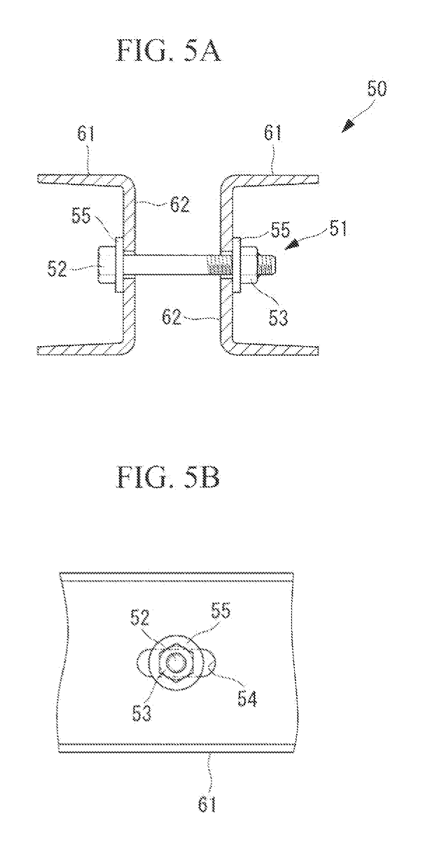

A tube arrangement fitting for heat transfer tubes according to a third embodiment of the present invention will be explained with reference to FIG. 5A and FIG. 5B. FIG. 5A is a drawing that shows a state in which the tube arrangement fitting for heat transfer tubes according to the present invention is assembled, and is a cross-sectional view at locations where the fastening sections are disposed. FIG. 5B is a drawing in which the cross-sectional view shown in FIG. 1 is viewed from the right side.

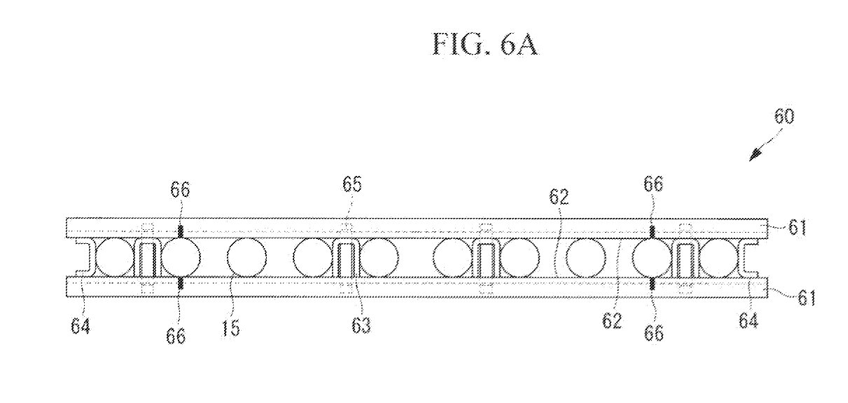

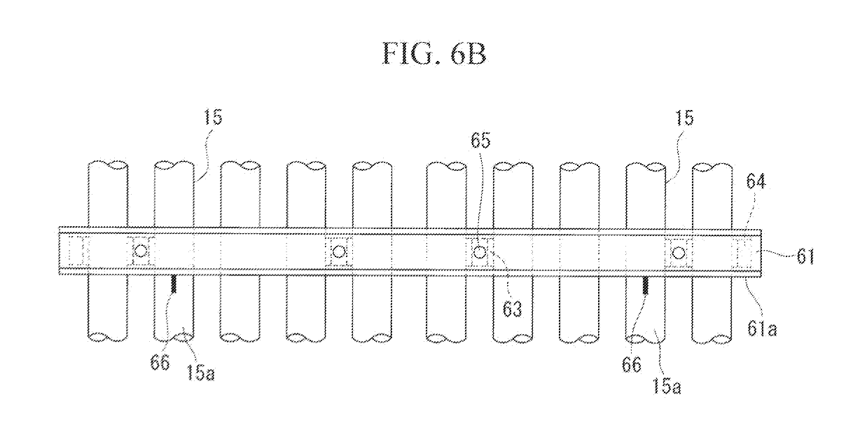

The tube arrangement fitting 50 for heat transfer tubes according to the present invention differs from the tube arrangement fitting 60 for heat transfer tubes explained in FIG. 6A and FIG. 6B on the point that a bolt 52 and a nut 53 are used as the fastening section 51, and a long hole 54 is provided along the length direction of the plate-like member 61 in the plate-like member 61 that is disposed on the nut 53 side. The other structural elements are identical to the tube arrangement fitting 60 for heat transfer tubes explained by using FIG. 6A and FIG. 6B, and here, the explanation of these structural elements will be omitted.

Note reference numeral 55 in FIG. 5A and FIG. 5B is a washer. In addition, in order to simplify the figures, the spacer 63 is not shown in FIG. 5A and FIG. 5B.

In the tube arrangement fitting 50 for heat transfer tubes according to the present embodiment, even if one plate-like member 61 expands or contracts, this expansion and contraction is tolerated (absorbed) by the long hole 54, and thus, deflection (bend) in the length direction due to a difference in heat expansion between the two plate-like members 61, between which the rows of heat transfer tubes are sandwiched, can be reduced, and deflection (bend) of the rows of heat transfer tubes can be prevented.

In addition, in the tube arrangement fitting 50 of the heat transfer tubes according to the present embodiment, for example, the lower surface of one plate-like member 61 and the outer surface 15a (refer to FIG. 6B) of the heat transfer tubes 15 (refer to FIG. 6A and FIG. 6B) are joined by welding at locations separated by a predetermined interval (within a necessary minimum range), and attached to the rows of heat transfer tubes.

Thereby, the welded section 66 (refer to FIG. 6B) for attaching the tube arrangement fitting 50 for heat transfer tubes to the rows of heat transfer tubes can be reduced to a minimum, and restoration and sensitization due to heating input of the shot blast treated layer that has been applied to the surface inside the tube can be prevented.

Furthermore, in the tube arrangement fitting 50 for heat transfer tubes according to the present embodiment, the length of the spacers 63 in a direction perpendicular to the lengthwise direction axis of the plate-like member 61 is set so as to be greater than the diameter of the heat transfer tubes 15 and the length of the plate-like member 61 along the lengthwise direction axis is set so as to be less than the distance between adjacent heat transfer tubes 15, and thus, the expansion and contraction of the heat transfer tubes 15 in the radial direction and the expansion and contraction of the heat transfer tubes 15 in the longitudinal direction (axial direction) can be tolerated, and deformation due to the expansion and contraction of the heat transfer tubes 15 in the radial direction and the expansion and contraction of the heat transfer tubes 15 in the longitudinal direction can be prevented.

Note that the present invention is not limited by the embodiments described above, and that alterations and modifications are possible according to suitable necessity within a range that does not depart from the technical conception of the present invention.

### REFERENCE SIGNS LIST

10 tube arrangement fitting for heat transfer tubes
11 plate-like member
12 cutout
13 rectilinear section
14 semicircular section
15 heat transfer tube
17 side surface
18 tongue section
30 tube arrangement fitting for heat transfer tubes
31 first plate-like member
32 second plate-like member
33 back surface
34 back surface
35 spacer
37 fastening member
38 side surface (outer surface)
39 holding member
50 tube arrangement fitting for heat transfer tubes
52 bolt
53 nut
54 long hole
60 tube arrangement fitting for heat transfer tubes
61 plate-like member
62 back surface
63 spacer
65 fastening member

1. A metal tube arrangement fitting for heat transfer tubes that holds heat transfer tubes that are arranged substantially in parallel at a predetermined interval and prevents the misalignment of the rows of heat transfer tubes, comprising:
two long plate-like members in which a plurality of cutouts is provided along the longitudinal direction thereof on one side in the width direction, wherein
each of the cutouts includes two rectilinear sections that extend in a direction perpendicular to the longitudinal direction axis of the plate-like members and a semicircular section that links one end of these rectilinear sections together;
the distance between the two rectilinear sections along the longitudinal direction axis of the plate-like members and the diameter of the semicircular section are set so as to be greater than the diameter of the heat transfer tubes that are contained within the cutouts; and
tongue sections are respectively provided between adjacent cutouts and between cutouts positioned at both end sections of the plate-like members in the lengthwise direction and both side surfaces in the longitudinal direction of the plate-like members.

2. A metal tube arrangement fitting for heat transfer tubes that holds heat transfer tubes arranged substantially in parallel at a predetermined interval and prevents misalignment of the rows of heat transfer tubes, comprising:
a long first plate-like member that exhibits a cross-sectional square “U” shape;
a second plate-like member that is longer than the first plate-like member and exhibits a cross-sectional square “U” shape;
spacers that are disposed between adjacent heat transfer tubes, and are fit between the back surface of the first plate-like member and the back surface of the second plate-like member;
fastening members that link the first plate-like member and the second plate-like member; and
holding members, which exhibit a cross-sectional squared “U” shape, are attached to the outer surface of both end sections of the first plate-like member in the width direction, and hold the second plate-like member in a state in which the expansion and contraction in the longitudinal direction thereof is not restricted; wherein
the length of the spacers in a direction perpendicular to the longitudinal direction axis of the first plate-like member and the second plate-like member is set so as to be greater than the diameter of the heat transfer tubes, and the length along the longitudinal direction axis of the first plate-like member and the second plate-like member is set so as to be less than the distance between adjacent heat transfer tubes.

3. A metal tube arrangement fitting for heat transfer tubes according to claim 2, wherein the fastening member is disposed only at the center of the first plate-like member and the second plate-like member in the longitudinal direction.

4. A metal tube arrangement fitting for heat transfer tubes according to claim 1, wherein the spacers are disposed between all adjacent heat transfer tubes.

5. A metal tube arrangement fitting for heat transfer tubes that holds heat transfer tubes arranged substantially in parallel at a predetermined distance and prevents the misalignment of the rows of heat transfer tubes, comprising:
two long plate-like members that exhibit a cross-sectional square “U” shape;
spacers that are disposed between adjacent heat transfer tubes and are sandwiched between the back surfaces of the plate-shaped members: and
a bolt and nut that link the plate-like members together, wherein
the length of the spacers, in a direction perpendicular to the lengthwise direction axis of the plate-like members, is set so as to be greater than the diameter of the heat transfer tubes, and the length of the plate-like members, along the lengthwise direction axis, is set so as to be less than the distance between adjacent heat transfer tubes; and
a long hole, into which the distal end section of the bolt on the nut side is received, is provided along the lengthwise direction axis of the plate-like member in the plate-like member disposed at the nut side.

6. A boiler comprising the metal tube arrangement fitting for heat transfer tubes according to claim 1.

7. A boiler comprising the metal tube arrangement fitting for heat transfer tubes according to claim 2.

8. A boiler comprising the metal tube arrangement fitting for heat transfer tubes according to claim 5.

9. A metal tube arrangement fitting for heat transfer tubes according to claim 2, wherein the spacers are disposed between all adjacent heat transfer tubes.
